(19) United States
(12) Patent Application Publication
(10) Pub. No.: US 2025/0337207 A1
(43) Pub. Date: Oct. 30, 2025

(54) BUSBAR HOLDER AND BUSBAR HOLDER MANUFACTURING METHOD

(71) Applicant: Yazaki Corporation, Tokyo (JP)

(72) Inventors: Takayuki MIZUNUMA, Tochigi (JP); Yusuke KATAZAWA, Tochigi (JP); Chikara KATONO, Tochigi (JP); Atsushi OKADA, Tochigi (JP)

(73) Assignee: Yazaki Corporation, Tokyo (JP)

(21) Appl. No.: 19/090,661

(22) Filed: Mar. 26, 2025

(30) Foreign Application Priority Data
Apr. 30, 2024 (JP) 2024-073425

(51) Int. Cl. H01R 25/14; H01R 13/424; H01R 13/506

(52) U.S. Cl. CPC H01R 25/145; H01R 13/424; H01R 13/506; H01R 2201/26

(57) ABSTRACT

A busbar holder includes a base, a cover, and a lock member. The base includes a groove that slidably supports the cover in an axial direction, and a pair of locking portions provided at both ends in a width direction. The cover includes a through hole penetrating the cover in a stacking direction. The lock member includes: a protrusion protruding in the stacking direction, and provided to be inserted into the through hole of the cover to clamp a busbar between the protrusion and the base; and a pair of locked portions being provided at both ends in the width direction and provided to be locked to the pair of locking portions of the base in a state where the protrusion is inserted into the through hole.

### CROSS-REFERENCE TO RELATED APPLICATION(S)

The present application claims priority to and incorporates by reference the entire contents of Japanese Patent Application No. 2024-073425 filed in Japan on Apr. 30, 2024.

### BACKGROUND OF THE INVENTION

### 1. Field of the Invention

The present invention relates to a busbar holder and a busbar holder manufacturing method.

### 2. Description of the Related Art

As an example of a technique related to a conventional busbar holder, JP 2023-1851 A discloses a busbar holder including: a base provided with an insertion space through which a busbar is inserted in an axial direction; and a cover assembled to the base in the axial direction and provided to cover the insertion space from one end side in a stacking direction.

Meanwhile, the busbar holder described in JP 2023-1851 A described above has room for further improvement in terms of enhancement in assemblability to the busbar, for example.

### SUMMARY OF THE INVENTION

The present invention has been made in view of the above circumstances, and aims to provide a busbar holder and a busbar holder manufacturing method capable of enhancing assemblability to a busbar.

In order to achieve the above mentioned object, a busbar holder according to one aspect of the present invention includes a base provided with an insertion space through which a busbar is inserted in an axial direction; a cover to be assembled to the base in the axial direction and provided to cover the insertion space from one end side in a stacking direction intersecting the axial direction; and a lock member assembled to the base and the cover in the stacking direction, wherein the base includes a groove provided to slidably support the cover in the axial direction, and a pair of locking portions provided at both ends in a width direction intersecting both the axial direction and the stacking direction, the cover includes a through hole penetrating the cover in the stacking direction, and the lock member includes a protrusion protruding in the stacking direction to be inserted into the through hole of the cover, and provided to clamp the busbar between the base and the protrusion, and a pair of locked portions being provided at both ends in the width direction, and provided to be locked to the pair of locking portions of the base in a state where the protrusion is inserted into the through hole.

In order to achieve the above mentioned object, a busbar holder manufacturing method according to another aspect of the present invention includes a first step of inserting a busbar into an insertion space in an axial direction to assemble the busbar to a base in which the insertion space is provided; a second step of sliding a cover in the axial direction to assemble the cover to the base, the cover covering the insertion space from one end side in a stacking direction intersecting the axial direction; and a third step of assembling and fixing a lock member to the base and the cover in the stacking direction, the lock member including a protrusion to be inserted into a through hole on the cover and provided to clamp the busbar between the protrusion and the base, the lock member further including a pair of locked portions, the pair of locked portions being provided at both ends in a width direction intersecting the axial direction and the stacking direction and provided to be locked to a pair of locking portions on the base in a state where the protrusion is inserted into the through hole.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exemplary perspective view of a routing structure of a busbar to which a busbar holder according to an embodiment is applied;

FIG. 2 is an exemplary exploded perspective view of the busbar holder according to the embodiment;

FIG. 3 is an exemplary perspective view of the busbar holder according to the embodiment;

FIG. 4 is an exemplary perspective view of the busbar holder according to the embodiment as viewed from an angle different from the angle of FIG. 3;

FIG. 5 is an exemplary cross-sectional view of a fixing unit of the busbar holder according to the embodiment;

FIG. 6 is an exemplary perspective view illustrating a busbar holder manufacturing method according to the embodiment, and is a view illustrating a first step;

FIG. 7 is an exemplary perspective view illustrating the busbar holder manufacturing method according to the embodiment, and is a view illustrating a second step;

FIG. 8 is an exemplary perspective view illustrating the busbar holder manufacturing method according to the embodiment, and is a view illustrating a third step;

FIG. 9 is an exemplary flowchart of the busbar holder manufacturing method according to the embodiment;

FIG. 10 is an exemplary perspective view of a routing structure of a busbar to which a busbar holder according to a modification is applied;

FIG. 11 is an exemplary exploded perspective view of the busbar holder according to the modification;

FIG. 12 is an exemplary perspective view of the busbar holder according to the modification;

FIG. 13 is an exemplary perspective view of the busbar holder according to the modification, as viewed from an angle different from the angle of FIG. 12;

FIG. 14 is an exemplary perspective view illustrating a busbar holder manufacturing method according to a modification, and is a view illustrating a first step;

FIG. 15 is an exemplary perspective view illustrating the busbar holder manufacturing method according to the modification, and is a view illustrating a second step; and

FIG. 16 is an exemplary perspective view illustrating the busbar holder manufacturing method according to the modification, and is a view illustrating a third step.

### DETAILED DESCRIPTION OF THE PREFERRED EMBODIMENTS

Embodiments and modifications according to the present invention will be described below in detail with reference to the drawings. Note that the present invention is not limited by the following embodiments and modifications. Moreover, components in the following embodiments and modifications include those easily interchangeable by those skilled in the art or substantially identical.

In addition, the embodiments and modifications disclosed below include similar components. Therefore, in the following description, common reference numerals are attached to these similar components, and redundant description is omitted. In the present specification, ordinal numbers are used merely to distinguish components, members, parts, positions, directions, and the like, and do not indicate order or priority.

### Embodiment

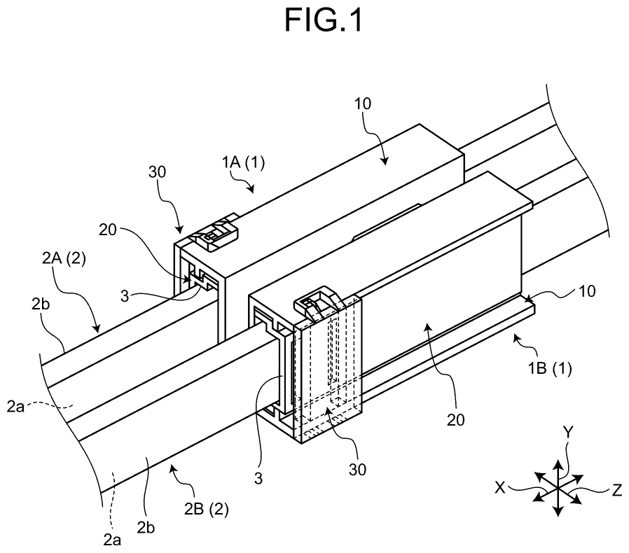

FIG. 1 is a perspective view of a routing structure of a busbar to which a busbar holder 1 according to the embodiment is applied. The busbar holder 1 of the present embodiment illustrated in FIG. 1 is incorporated in a busbar 2 applicable to power distribution of a battery mounted on a vehicle such as an automobile. Here, the busbar holder 1 includes, for example: a first holder 1A assembled to a first busbar 2A of the busbar 2; and a second holder 1B assembled to a second busbar 2B of the busbar 2. One of the first busbar 2A and the second busbar 2B is the busbar 2 on the positive electrode side, while the other is the busbar 2 on the negative electrode side.

In the present embodiment, in the busbar holder 1, the first holder 1A and the second holder 1B are constituted with an identical component. That is, the specification of the first holder 1A is the same as the specification of the second holder 1B. The busbar 2 includes, for example, a straight portion extending in an axial direction X and an intersecting portion intersecting the straight portion, and is formed in a crank shape as a whole. The busbar holder 1, assembled to a straight portion of the busbar 2, for example, is fixed to a fixing target portion of the vehicle to support the busbar 2. This makes it possible to fix and support the busbar 2 along a routing path.

The following description uses a first direction, a second direction, and a third direction intersecting each other, in which the first direction is denoted as an “axial direction X”, the second direction is denoted as a “width direction Y”, and the third direction is denoted as a “stacking direction Z”. The axial direction X, the width direction Y, and the stacking direction Z are substantially orthogonal to each other. The axial direction X typically runs in an extending direction of the straight portion of the busbar 2, an insertion direction of the busbar 2 with respect to the busbar holder 1, a longitudinal direction (extending direction) of the busbar holder 1, and the like. The width direction Y typically runs in the width direction of the busbar 2, the width direction of the busbar holder 1, and the like. The stacking direction Z typically runs in a plate thickness direction of the busbar 2, a height direction of the busbar holder 1, a stacking direction of a base 10, a cover 20, and a lock member 30, which will be described below, of the busbar holder 1, and the like. Furthermore, each of directions used in the following will be described as a direction in a state where the busbar holder 1 has been assembled to the busbar 2, unless otherwise specified.

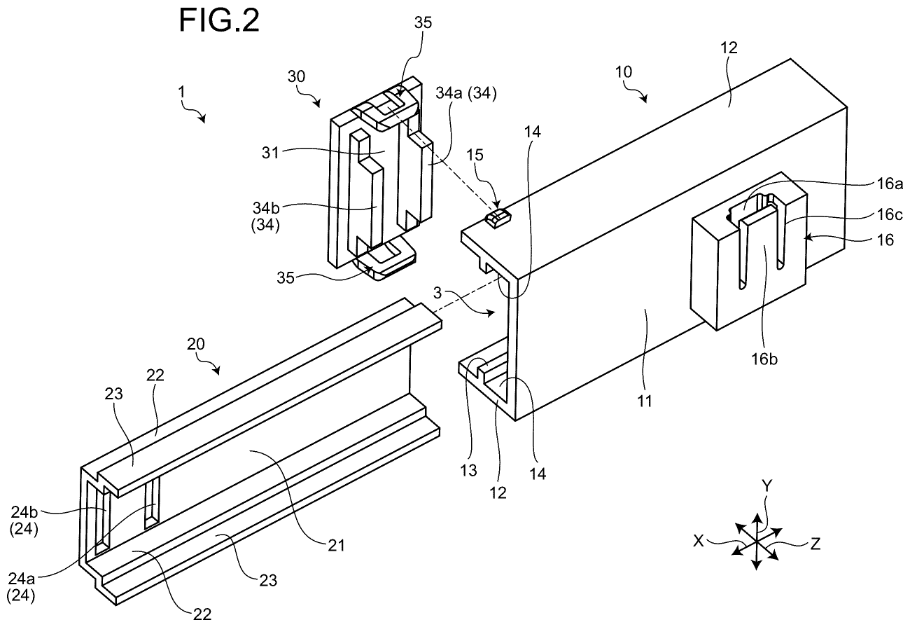

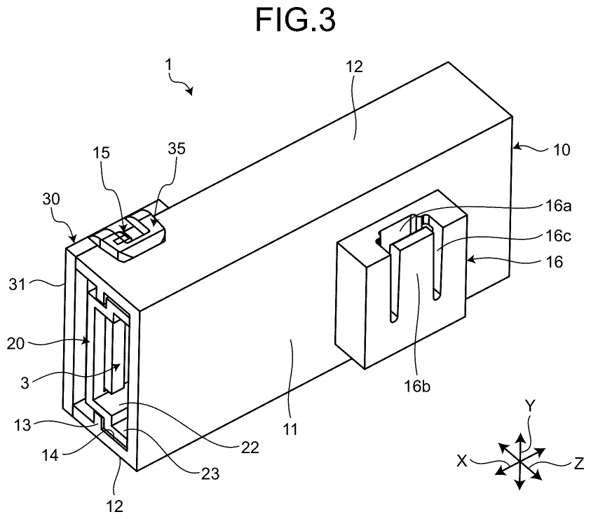

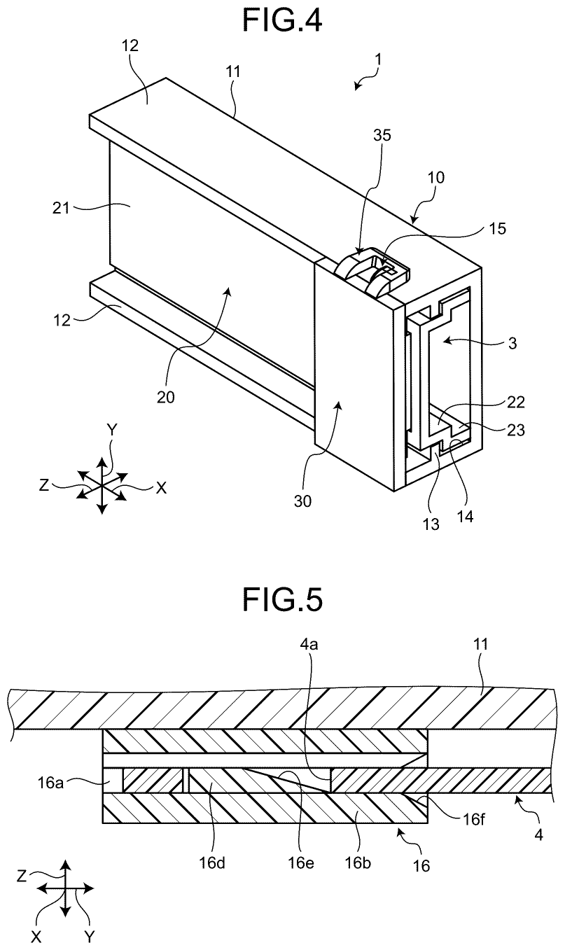

FIG. 2 is an exploded perspective view of the busbar holder 1, FIG. 3 is a perspective view of the busbar holder 1, and FIG. 4 is a perspective view of the busbar holder 1 as viewed from an angle different from the angle of FIG. 3. As illustrated in FIGS. 2 to 4, the busbar holder 1 includes the base 10, the cover 20, and the lock member 30, for example. That is, the first holder 1A and the second holder 1B described above each include the base 10, the cover 20, and the lock member 30. In other words, the base 10 includes: a first base assembled to the first busbar 2A described above; and a second base assembled to the second busbar 2B, while the cover 20 includes: a first cover assembled to the first base in the axial direction X; and a second cover assembled to the second base in the axial direction X. The lock member 30 includes: a first lock member assembled to the first base and the first cover in the stacking direction Z; and a second lock member assembled to the second base and the second cover in the stacking direction Z.

The base 10 has an insertion space 3, being formed as a space through which the busbar 2 is inserted in the axial direction X. For example, the insertion space 3 penetrates the base 10 in the axial direction X, with one end side of the insertion space 3 open in the stacking direction Z. The base 10 includes a base-side bottom wall 11, a pair of base-side side walls 12, a groove 14, a pair of locking portions 15, and a fixing unit 16 described below, for example. The base 10 has a configuration, for example, in which the base-side bottom wall 11, the pair of base-side side walls 12, the pair of locking portions 15, and the fixing unit 16 are integrally formed of a material such as synthetic resin. The base-side bottom wall 11 and the pair of base-side side walls 12 are structures for partitioning the insertion space 3 of the base 10. The insertion space 3 is a space through which the above-described busbar 2 is inserted and routed. The base-side bottom wall 11 is formed in a flat plate shape extending laterally long in the axial direction X. The pair of base-side side walls 12 protrudes from both ends of the base-side bottom wall 11 in the width direction Y toward one end side in the stacking direction Z, and extends in the axial direction X.

The pair of base-side side walls 12 is provided with a pair of projections 13 protruding toward the sides approaching each other in the width direction Y. The pair of projections 13 extends in the axial direction X so as to extend between one end and the other end of the pair of base-side side walls 12 in the axial direction X. In the present embodiment, the groove 14 is provided on the proximal end side of the pair of projection 13. The groove 14 is a set groove that slidably supports the cover 20 in the axial direction X. The groove 14 is surrounded by the pair of projections 13, the pair of base-side side walls 12, and the base-side bottom wall 11, and is formed as a recess being recessed in the width direction Y more than the distal end of the pair of projections 13.

The pair of locking portions 15 are portions to be used for locking with a locked portion 35 being a portion of the lock member 30 to be described below. For example, the pair of locking portions 15 is formed in a claw shape on the outer surfaces of the pair of base-side side walls 12. That is, the pair of locking portions 15 is provided at both ends of the base 10 in the width direction Y. In the present embodiment, the pair of locking portions 15 is provided at one end of the pair of base-side side walls 12 in the axial direction X. The pair of locking portions 15 each has a locking surface facing the locked portion 35 in the stacking direction Z. The locking surface and the locked portion 35 are locked in the stacking direction Z, allowing the lock member 30 to be locked to the base 10.

The cover 20 covers the insertion space 3 formed in the base 10 from one end side in the stacking direction Z. The cover 20 includes a cover-side bottom wall 21, a pair of cover-side side walls 22, and a through hole 24, for example. The cover 20 has the cover-side bottom wall 21 and the pair of cover-side side walls 22 integrally formed of a material such as synthetic resin, for example. The cover-side bottom wall 21 and the pair of cover-side side walls 22 are structures for partitioning the insertion space 3, together with the base 10. The insertion space 3 is a space through which the above-described busbar 2 is inserted and routed. The cover-side bottom wall 21 is formed in a flat plate shape extending laterally long in the axial direction X. The pair of cover-side side walls 22 protrudes from both ends of the cover-side bottom wall 21 in the width direction Y toward the other end side in the stacking direction Z, and extends in the axial direction X.

In addition, the pair of cover-side side walls 22 has a pair of protruding pieces 23 protruding in a step shape separating away from each other in the width direction Y, and protruding in a step shape in the stacking direction Z. The pair of protruding pieces 23 extends in the axial direction X so as to extend across one end and the other end of the pair of cover-side side walls 22 in the axial direction X. In the present embodiment, the pair of protruding pieces 23 is inserted into and engaged with the groove 14 of the base 10. The thickness of the pair of protruding pieces 23 in the width direction Y is substantially the same as the depth of the pair of grooves 14 in the width direction Y. The lateral width of the pair of protruding pieces 23 in the stacking direction Z is substantially the same as a lateral width of the pair of grooves 14 in the stacking direction Z. In the present embodiment, the abutment between the pair of protruding pieces 23 and the pair of projection 13 suppresses the movement (detachment) of the cover 20 toward the one end side in the stacking direction Z with respect to the base 10.

The through hole 24 is a portion into which a protrusion 34 on the lock member 30, to be described below, is inserted. The through hole 24 is provided in the cover-side bottom wall 21 to penetrate the cover-side bottom wall 21 in the stacking direction Z. In the present embodiment, the through hole 24 is provided at one end of the cover-side bottom wall 21 in the axial direction X. The through hole 24 includes: a first through hole 24a into which a first protrusion 34a of the protrusion 34 is inserted; and a second through hole 24b into which a second protrusion 34b of the protrusion 34 is inserted, for example. The first through hole 24a and the second through hole 24b are formed in a slit shape extending laterally long in the width direction Y, and are located apart from each other in the axial direction X, for example. In the present embodiment, with a configuration in which the first through hole 24a and the second through hole 24b are respectively engaged with the first protrusion 34a and the second protrusion 34b, it is possible restrict the movement of the cover 20 in the axial direction X with respect to the base 10 fixed by the lock member 30, specifically fixed via the locked portion 35.

The lock member 30 locks the cover 20 at a predetermined position with respect to the base 10. The lock member 30 includes, for example, a bottom wall 31, a protrusion 34, and a pair of the locked portions 35. The lock member 30 has the bottom wall 31, the protrusion 34, and the pair of locked portions 35 integrally formed of a material such as synthetic resin, for example. The bottom wall 31 is formed in a flat plate shape extending laterally long in the width direction Y. The lateral width of the bottom wall 31 in the width direction Y is substantially the same as a lateral width of the base-side bottom wall 11 in the width direction Y. The bottom wall 31 covers the open ends of the pair of base-side side walls 12 on the side opposite to the base-side bottom wall 11. The lock member 30 is also referred to as a lid member or the like.

The protrusion 34 protrudes from the bottom wall 31 toward the other end side (base 10 side) in the stacking direction Z and extends in the width direction Y. The protrusion 34 includes: the first protrusion 34a inserted into the first through hole 24a of the cover 20; and the second protrusion 34b inserted into the second through hole 24b of the cover 20, described above, for example. Each of the first protrusion 34a and the second protrusion 34b extends laterally long in the width direction Y and is located apart from each other in the axial direction X. That is, in the present embodiment, the first protrusion 34a and the second protrusion 34b are provided in parallel to each other. The first protrusion 34a and the second protrusion 34b function as portions to clamp the busbar 2 between the protrusions and the base-side bottom wall 11.

The pair of locked portions 35 are portions used for locking with the pair of locking portions 15 of the base 10 described above. The pair of locked portions 35 is provided, for example, at both ends of the bottom wall 31 in the width direction Y, and is formed in a locking hole shape into which the pair of locking portions 15 is inserted. Each of the pair of locked portions 35 has a locked surface facing the locking portion 15 in the stacking direction Z. The locked surface and the locking surface of the locking portion 15 are locked in the stacking direction Z in a state where the first protrusion 34a and the second protrusion 34b are respectively inserted into the first through hole 24a and the second through hole 24b of the cover 20, allowing the lock member 30 and the cover 20 to be locked to the base 10.

FIG. 5 is a cross-sectional view of the fixing unit 16 of the busbar holder 1. As illustrated in FIG. 5, the fixing unit 16 is a portion to which a stay 4 of a vehicle is fixed. The fixing unit 16 is provided on the outer surface of the base-side bottom wall 11 of the base 10 described above. The fixing unit 16 includes: an insertion hole 16a into which the stay 4 is inserted in the width direction Y; and a locking piece 16b with which the stay 4 is locked in the width direction Y, for example. The insertion hole 16a is formed as a through hole penetrating the fixing unit 16 in the width direction Y. In the present embodiment, at an open end on one end side in the width direction Y of the insertion hole 16a, there is provided a tapered surface 16f for enhancing insertability of the stay 4. The tapered surface 16f is inclined toward both sides in the stacking direction Z and both sides in the axial direction X as running toward one end side in the width direction Y.

For example, the locking piece 16b is formed in a cantilever spring-like shape on a peripheral wall on the other end side (side opposite to the base-side bottom wall 11) of the insertion hole 16a in the stacking direction Z. Specifically, the locking piece 16b is configured such that one end side (tapered surface 16f side) in the width direction Y is connected to the peripheral wall of the fixing unit 16, while the other end side in the width direction Y is formed as a free end elastically deformable in the stacking direction Z. On either side of the locking piece 16b in the axial direction X, there is provided a pair of slits 16c (refer to FIG. 3) extending in the width direction Y. The pair of slits 16c extends from an intermediate position on one end side of the peripheral wall of the fixing unit 16 in the width direction Y toward the other end side in the width direction Y, and opens to the other end side in the width direction Y.

The locking piece 16b has a projection 16d (refer to FIG. 5) protruding in the stacking direction Z. The projection 16d is a portion to be engaged with an opening 4a provided at the distal end of the stay 4. The stay 4 is formed in a flat plate shape extending laterally long in the width direction Y, for example, and the opening 4a is formed as a through hole penetrating the stay 4 in the stacking direction Z. In the present embodiment, on one end side of the projection 16d in the width direction Y, there is provided an inclined surface 16e for guiding the distal end of the stay 4. The inclined surface 16e is inclined toward the other end side (locking piece 16b side) in the stacking direction Z as running from the top of the projection 16d toward the one end side in the width direction Y.

In the present embodiment, the distal end of the stay 4 is inserted into the insertion hole 16a of the fixing unit 16 having the above-described configuration from one end side (tapered surface 16f side) in the width direction Y. The distal end of the stay 4 is guided along the inclined surface 16e of the projection 16d, allowing the free end on the other end side in the width direction Y of the locking piece 16b to be elastically deformed in the stacking direction Z. When the distal end of the stay 4 gets over the projection 16d, the locking piece 16b returns to the free state, allowing the projection 16d to be inserted into and engaged with the opening 4a of the stay 4. In this state, the inner surface of the opening 4a and the locking surface of the projection 16d are locked in the width direction Y, and the stay 4 is locked (fixed) to the fixing unit 16.

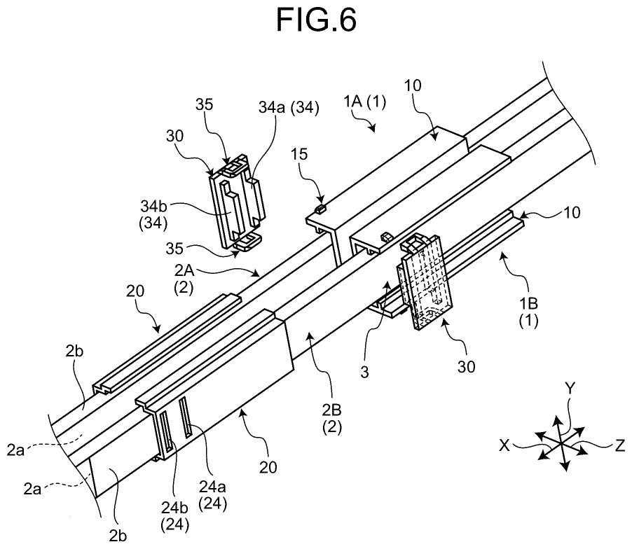

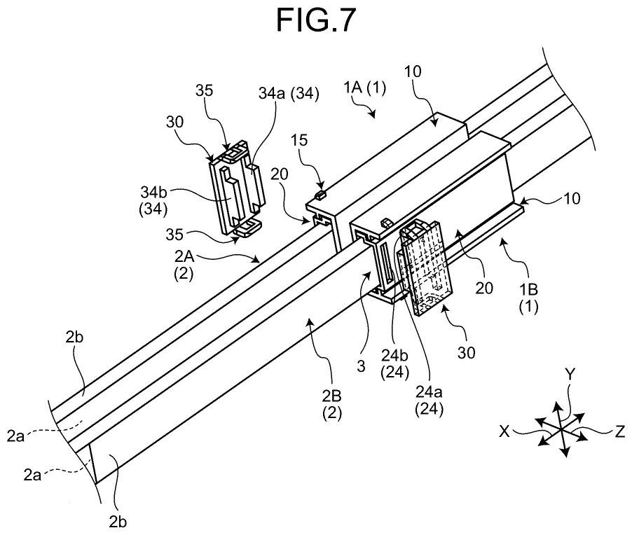

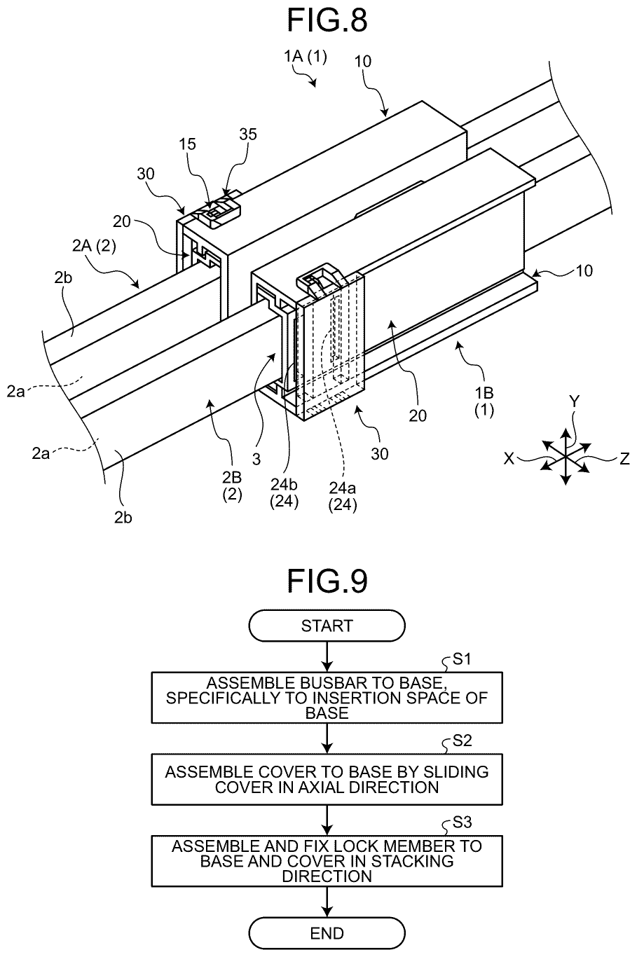

Next, an example of a method of manufacturing (assembling) the busbar holder 1 having the above configuration will be described. FIG. 6 is a perspective view illustrating the method of manufacturing the busbar holder 1 and is a view illustrating a first step S1. FIG. 7 is a perspective view illustrating the method of manufacturing the busbar holder 1 and is a view illustrating a second step S2. FIG. 8 is a perspective view illustrating the method of manufacturing the busbar holder 1 and is a view illustrating a third step S3. FIG. 9 is a flowchart of a method for manufacturing the busbar holder 1.

First, in the process of the first step S1, as illustrated in FIGS. 6 and 9, the busbar 2 is inserted into the insertion space 3 in the axial direction X and assembled to the base 10. In this case, for example, the busbar holder 1 is disposed in a state where the insertion spaces 3 of the pair of bases 10 are open in mutually opposite directions in the stacking direction Z, and the busbar 2 is inserted into each of the insertion spaces 3 in the stacking direction Z. That is, the first holder 1A of the busbar holder 1 is disposed in a state where the insertion space 3 of the base 10 is open toward the one end side in the stacking direction Z, while the first busbar 2A of the busbar 2 is inserted into the insertion space 3 from the one end side in the stacking direction Z. On the other hand, the second holder 1B of the busbar holder 1 is disposed in a state where the insertion space 3 of the base 10 is open toward the other end side in the stacking direction Z, while the second busbar 2B of the busbar 2 is inserted into the insertion space 3 from the other end side in the stacking direction Z.

At this time, in the present embodiment, the busbar 2 includes: a busbar body 2a having conductivity; and an insulating sheath 2b having an insulating property and configured to cover the busbar body 2a, and the busbar holder 1 is assembled to the insulating sheath 2b of the busbar 2. The insulating sheath 2b is provided, for example, over substantially the whole of the straight portion of the busbar 2 extending in the axial direction X. The pair of bases 10. the pair of covers 20, and the pair of lock members 30 of the busbar holder 1 are assembled at predetermined positions of the insulating sheath 2b.

Next, in the process of the second step S2, as illustrated in FIGS. 7 and 9, the cover 20 is slid in the axial direction X so as to be assembled to the base 10. In this case, the busbar holder 1 undergoes a process, for example, in which the pair of covers 20 is set at a position (refer to FIG. 6) shifted from the pair of bases 10 in the busbar 2 in the axial direction X, and in this state, the pair of covers 20 is slid toward the pair of bases 10 in the axial direction X so as to be inserted into the pair of bases 10.

Next, in the process of the third step S3, as illustrated in FIGS. 8 and 9, the lock member 30 is assembled and fixed to the base 10 and the cover 20 in the stacking direction Z. In this case, the busbar holder 1 undergoes a process, for example, in which the protrusions 34 of the pair of lock members 30 are each inserted into the through holes 24 of the pair of covers 20 from directions opposite to each other in the stacking direction Z, and, together with this, the individual locked portions 35 are locked to the locking portions 15 of the pair of bases 10. With the first step S1 to the third step S3 like this, the first holder 1A and the second holder 1B (the pair of bases 10, the pair of covers 20, and the pair of lock members 30) of the busbar holder 1 are respectively assembled to the first busbar 2A and the second busbar 2B of the busbar 2, making it possible to manufacture the busbar holder 1.

In the present embodiment, when removing the busbar 2 from the busbar holder 1, it is possible to remove the first busbar 2A and the second busbar 2B of the busbar 2 in opposite directions (separating directions) in the stacking direction Z. This makes it possible to suppress a situation in which the first busbar 2A and the second busbar 2B are close to each other exceeding a certain distance or more, and possible to remove one busbar 2, that is, one of the first busbar 2A and the second busbar 2B, first in order, having an advantage of suppressing a short circuit in the busbar 2.

As described above, in the busbar holder 1 and the method of manufacturing the busbar holder 1 of the present embodiment, the lock member 30 includes: the protrusion 34 to be inserted into the through hole 24 of the cover 20 to clamp the busbar 2 between the protrusion 34 and the base 10; and the pair of locked portions 35 being provided at both ends in the width direction Y so as to be locked to the pair of locking portions 15 of the base 10 in a state where the protrusion 34 is inserted into the through hole 24. With this configuration, in the busbar holder 1 and the method of manufacturing the busbar holder 1, the base 10, the cover 20, and the lock member 30 can be assembled and fixed to any position of the straight line extending in the axial direction X of the busbar 2 by the protrusion 34 of the lock member 30 and the pair of locked portions 35, for example. As a result, the busbar holder 1 and the method of manufacturing the busbar holder 1 make it possible to enhance the assemblability to the busbar 2.

In the busbar holder 1 of the present embodiment, the protrusion 34 includes the first protrusion 34a extending in the width direction Y and the second protrusion 34b extending parallel to the first protrusion 34a, while the through hole 24 includes the first through hole 24a into which the first protrusion 34a is inserted and the second through hole 24b into which the second protrusion 34b is inserted. With this configuration, the busbar holder 1 can clamp the busbar 2 by the plurality of first protrusions 34a and the plurality of second protrusions 34b, for example, making it possible to further suppress the movement of the busbar 2 in the axial direction X with respect to the lock member 30 and the base 10, and making it possible to further suppress the movement of the cover 20 in the axial direction X with respect to the lock member 30 and the base 10 by the engagement between the plurality of first protrusions 34a and the second protrusions 34b with the first through hole 24a and the second through hole 24b, respectively.

In the busbar holder 1 of the present embodiment, the base 10 further includes the fixing unit 16, the fixing unit 16 including: the insertion hole 16a into which the stay 4 on the vehicle is inserted in the width direction Y; and the locking piece 16b having a cantilever spring-like shape and provided on the peripheral wall of the insertion hole 16a to lock the stay 4 in the width direction Y. With this configuration, the busbar holder 1 can fix the base 10 relatively easily to the stay 4 (fixing target portion) on the vehicle by the insertion hole 16a and the locking piece 16b of the fixing unit 16, for example.

In the busbar holder 1 of the present embodiment, the busbar 2 includes: the busbar body 2a having conductivity; and the insulating sheath 2b having an insulating property and configured to cover the busbar body 2a, and in addition, the base 10, the cover 20, and the lock member 30 are assembled to the insulating sheath 2b of the busbar 2. With this configuration, the busbar holder 1 can more easily, more smoothly, or more appropriately perform the assembling operation onto the busbar 2, for example.

The busbar holder 1 of the present embodiment has a configuration in which the busbar 2 includes the pair of busbars, namely, the first busbar 2A and the second busbar 2B. The busbar holder 1 includes: the first holder 1A to be assembled to the first busbar 2A and having the base 10, the cover 20, and the lock member 30; and the second holder 1B to be assembled to the second busbar 2B, being formed separately from the first holder 1A, and having the base 10, the cover 20, and the lock member 30. With this configuration, in the busbar holder 1, for example, the first holder 1A and the second holder 1B can be separately assembled to the pair of first busbars 2A and the second busbars 2B of the busbar 2, respectively, making it possible to further enhance the assemblability onto the busbar 2.

### Modification

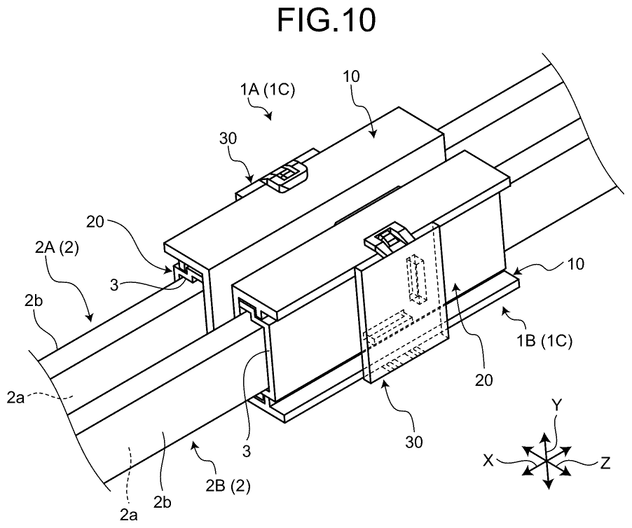

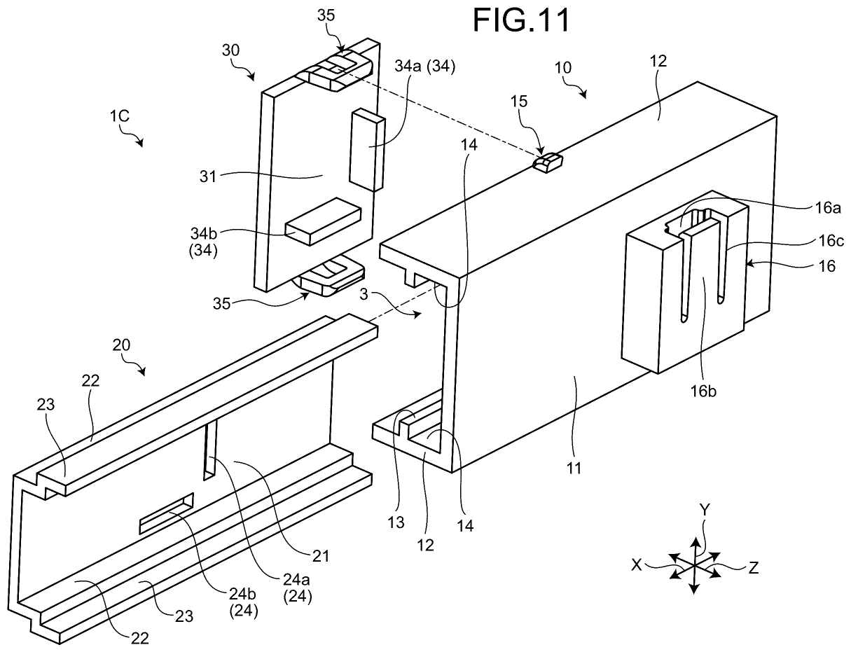

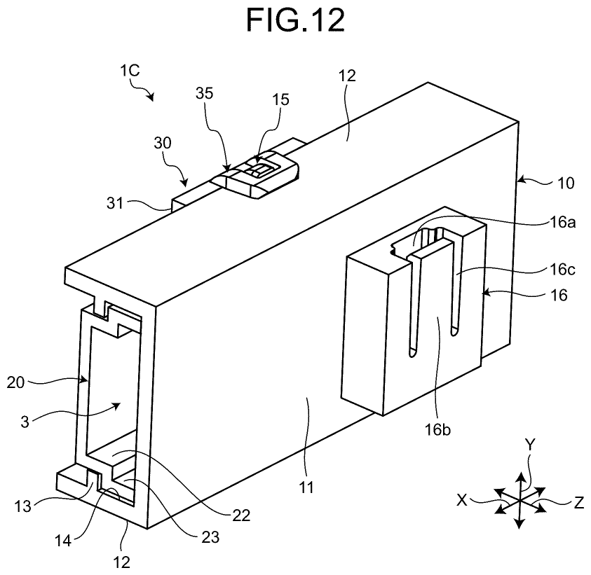

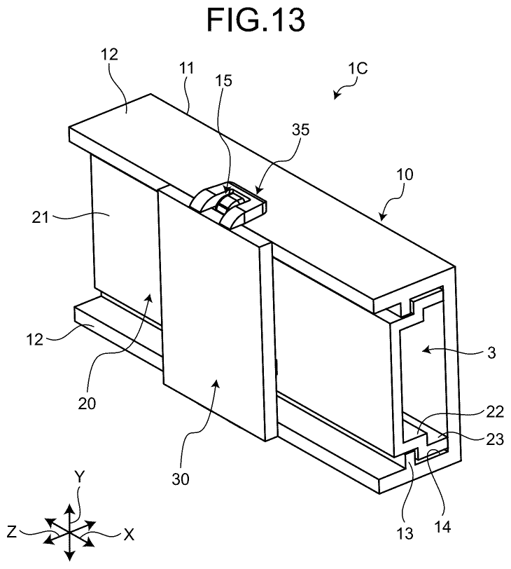

FIG. 10 is a perspective view of a routing structure of a busbar to which a busbar holder 1C according to a modification is applied. FIG. 11 is an exploded perspective view of the busbar holder 1C. FIG. 12 is a perspective view of the busbar holder 1C. FIG. 13 is a perspective view of the busbar holder 1C as viewed from an angle different from the angle of FIG. 12. A busbar holder 1C illustrated in FIGS. 10 to 13 has a configuration similar to the busbar holder 1 of the above embodiment. Accordingly, the busbar holder 1C can obtain functions and effects similar to those of the above-described embodiment based on the similar configuration.

However, as illustrated in FIGS. 10 to 13, the present modification is different from the above-described embodiment in that the lock member 30 is assembled to a substantially central portion of the base 10 in the axial direction X. Specifically, in the present modification, the pair of locking portions 15 of the base 10 is provided substantially at the central portion of the pair of base-side side walls 12 in the axial direction X, while the through hole 24 on the cover 20 is provided substantially at the central portion of the cover-side bottom wall 21 in the axial direction X. Furthermore, in the present modification, the first through hole 24a of the through hole 24 is formed in a slit shape extending laterally long in the width direction Y, while the second through hole 24b of the through hole 24 is formed in a slit shape extending laterally long in the axial direction X. The first through hole 24a and the second through hole 24b are provided apart from each other, and are formed in a substantially L shape when viewed in the stacking direction Z.

On the other hand, the first protrusion 34a of the protrusion 34 of the lock member 30 extends laterally long in the width direction Y, while the second protrusion 34b of the protrusion 34 extends laterally long in the axial direction X. The first protrusion 34a and the second protrusion 34b are provided apart from each other, and are formed in a substantially L shape when viewed in the stacking direction Z. That is, in the present modification, the first protrusion 34a and the second protrusion 34b are provided so as to intersect (to be orthogonal) with each other. In the present modification, with a configuration in which the first through hole 24a and the second through hole 24b are respectively engaged with the first protrusion 34a and the second protrusion 34b, it is possible restrict the movement of the cover 20 in the axial direction X with respect to the base 10 fixed by the lock member 30, specifically fixed via the locked portion 35.

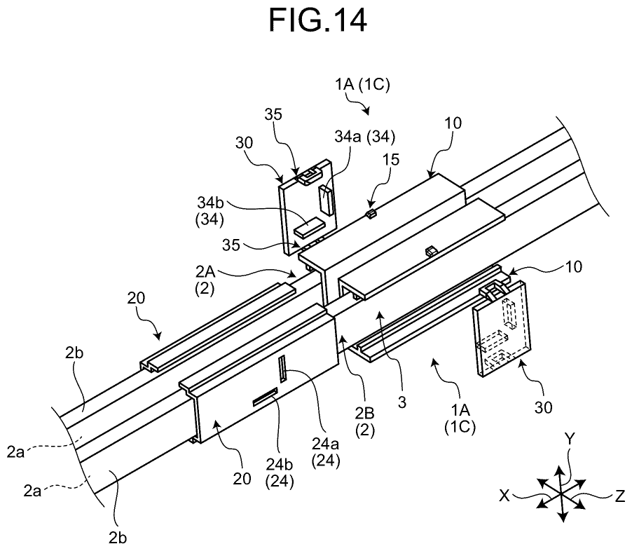

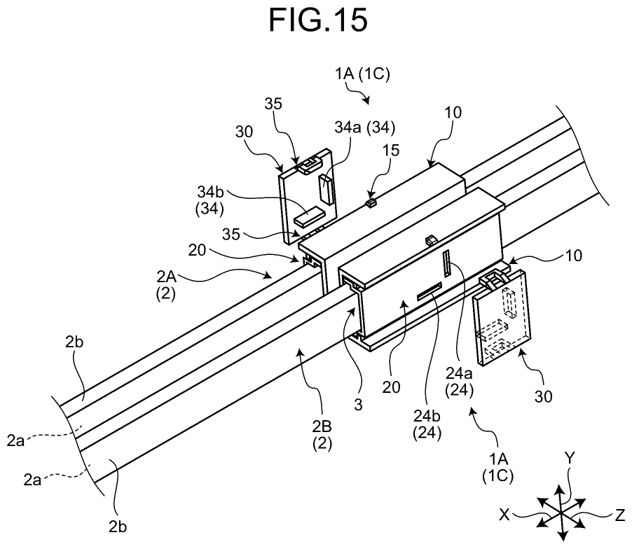

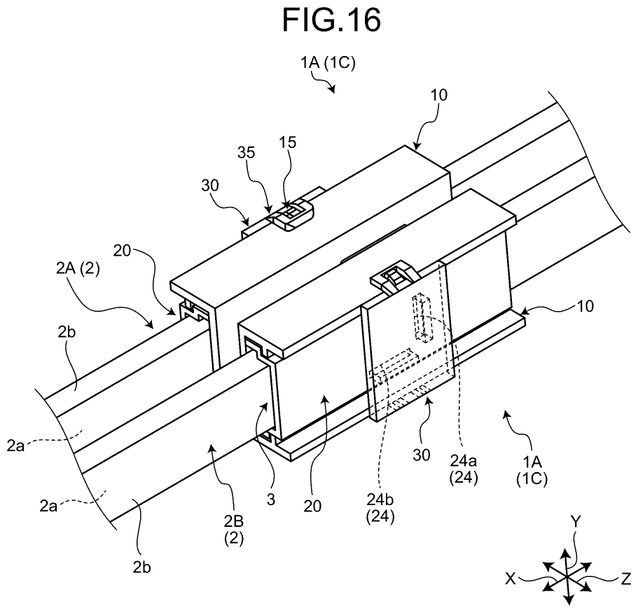

Next, an example of a method of manufacturing (assembling) the busbar holder 1C having the above configuration will be described. FIG. 14 is a perspective view illustrating the method of manufacturing the busbar holder 1C and is a view illustrating a first step S1. FIG. 15 is a perspective view illustrating the method of manufacturing the busbar holder 1C and is a view illustrating a second step S2. FIG. 16 is a perspective view illustrating the method of manufacturing the busbar holder 1C and is a view illustrating a third step S3.

First, in the process of the first step S1, as illustrated in FIG. 14, the busbar 2 is inserted into the insertion space 3 in the axial direction X and assembled to the base 10. In this case, for example, similarly to the above-described embodiment, the busbar holder 1C is disposed in a state where the insertion spaces 3 of the pair of bases 10 are open in mutually opposite directions in the stacking direction Z, and the first busbar 2A and the second busbar 2B of the busbar 2 are inserted into each of the insertion spaces 3 in the stacking direction z.

Next, in the process of the second step S2, as illustrated in FIG. 15, the cover 20 is slid in the axial direction X so as to be assembled to the base 10. In this case, the busbar holder 1C undergoes a process, for example, in which the pair of covers 20 is set at a position (refer to FIG. 14) shifted from the pair of bases 10 in the first busbar 2A and the second busbar 2B in the axial direction X, and in this state, the pair of covers 20 is slid toward the pair of bases 10 in the axial direction X so as to be inserted into the pair of bases 10.

Next, in the process of the third step S3, as illustrated in FIG. 16, the lock member 30 is assembled and fixed to the base 10 and the cover 20 in the stacking direction Z. In this case, the busbar holder 1C undergoes a process, for example, in which the protrusions 34 of the pair of lock members 30 are inserted into the through holes 24 of the pair of covers 20 from directions opposite to each other in the stacking direction Z, and, together with this, the individual locked portions 35 are locked to the locking portions 15 of the pair of bases 10. With the first step S1 to the third step S3, the first holder 1A and the second holder 1B (the pair of bases 10, the pair of covers 20, and the pair of lock members 30) of the busbar holder 1C are respectively assembled to the first busbar 2A and the second busbar 2B of the busbar 2, making it possible to manufacture the busbar holder 1C.

As described above, in the busbar holder 1C of the present modification, the protrusion 34 includes the first protrusion 34a extending in the width direction Y and the second protrusion 34b extending in the axial direction X intersecting the first protrusion 34a, while the through hole 24 includes the first through hole 24a into which the first protrusion 34a is inserted and the second through hole 24b into which the second protrusion 34b is inserted. With this configuration using the first protrusion 34a and the second protrusion 34b and the first through hole 24a and the second through hole 24b intersecting with each other, for example, the busbar holder 1C can further suppress the movement of the busbar 2 with respect to the lock member 30 and the base 10 in the axial direction X, and can further suppress the movement of the cover 20 with respect to the lock member 30 and the base 10 in the axial direction X.

The embodiment and the modifications described above use an exemplary configuration in which the busbar holders 1 and 1C include the first holder 1A and the second holder 1B, that is, the pair of bases 10, the pair of covers 20, and the pair of lock members 30. However, the configuration is not limited to this example, and the busbar holders 1 and 1C may include a single, or three or more bases 10, a single, or three or more covers 20, and a single, or three or more lock members 30.

Although the embodiment and modification of the present invention have been exemplified above, the above embodiment and modification are merely an example, and are not intended to limit the scope of the invention. The above embodiment and modification can be implemented in various other forms, and various omissions, substitutions, combinations, and change can be made without departing from the gist of the invention. In addition, the above embodiment and modification can be implemented by appropriately changing each configuration and specifications such as shape (structure, type, direction, form, size, length, width, thickness, height, number, arrangement, position, material, and the like).

In the busbar holder and the busbar holder manufacturing method according to the present embodiment, the lock member includes: a protrusion to be inserted into the through hole of the cover to clamp the busbar between the protrusion and the base; and a pair of locked portions being provided at both ends in the width direction so as to be locked to the pair of locking portions of the base in a state where the protrusion is inserted into the through hole. With this configuration, in the busbar holder and the busbar holder manufacturing method, the base, the cover, and the lock member can be assembled and fixed to any position of the straight line extending in the axial direction of the busbar by the protrusion of the lock member and the pair of locked portions, for example. As a result, the busbar holder and the busbar holder manufacturing method have an effect of enhancing the assemblability to the busbar.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A busbar holder comprising:
a base provided with an insertion space through which a busbar is inserted in an axial direction;
a cover to be assembled to the base in the axial direction and provided to cover the insertion space from one end side in a stacking direction intersecting the axial direction; and
a lock member assembled to the base and the cover in the stacking direction, wherein
the base includes a groove provided to slidably support the cover in the axial direction, and a pair of locking portions provided at both ends in a width direction intersecting both the axial direction and the stacking direction,
the cover includes a through hole penetrating the cover in the stacking direction, and
the lock member includes a protrusion protruding in the stacking direction to be inserted into the through hole of the cover, and provided to clamp the busbar between the base and the protrusion, and a pair of locked portions being provided at both ends in the width direction, and provided to be locked to the pair of locking portions of the base in a state where the protrusion is inserted into the through hole.

2. The busbar holder according to claim 1, wherein
the protrusion includes a first protrusion extending in the width direction, and a second protrusion extending in a direction parallel to the first protrusion or in the axial direction intersecting the first protrusion, and
the through hole includes a first through hole into which the first protrusion is inserted, and a second through hole into which the second protrusion is inserted.

3. The busbar holder according to claim 1, wherein
the base further includes a fixing unit that includes an insertion hole into which a stay on a vehicle is inserted in the width direction and a locking piece having a cantilever spring-like shape and being provided on a peripheral wall of the insertion hole to lock the stay in the width direction.

4. The busbar holder according to claim 2, wherein
the base further includes a fixing unit that includes an insertion hole into which a stay on a vehicle is inserted in the width direction and a locking piece having a cantilever spring-like shape and being provided on a peripheral wall of the insertion hole to lock the stay in the width direction.

5. The busbar holder according to claim 1, wherein
the busbar includes a busbar body having conductivity, and an insulating sheath having an insulating property and configured to cover the busbar body, and
the base, the cover, and the lock member are assembled to the insulating sheath of the busbar.

6. The busbar holder according to claim 2, wherein
the busbar includes a busbar body having conductivity, and an insulating sheath having an insulating property and configured to cover the busbar body, and
the base, the cover, and the lock member are assembled to the insulating sheath of the busbar.

7. The busbar holder according to claim 1, wherein
the busbar includes a pair of busbars, namely, a first busbar and a second busbar, and
the busbar holder further comprises:
a first holder assembled to the first busbar and having the base, the cover, and the lock member; and
a second holder assembled to the second busbar, the second holder being formed separately from the first holder, the second holder including the base, the cover, and the lock member.

8. The busbar holder according to claim 2, wherein
the busbar includes a pair of busbars, namely, a first busbar and a second busbar, and
the busbar holder further comprises:
a first holder assembled to the first busbar and having the base, the cover, and the lock member; and
a second holder assembled to the second busbar, the second holder being formed separately from the first holder, the second holder including the base, the cover, and the lock member.

9. A busbar holder manufacturing method, the method comprising:
a first step of inserting a busbar into an insertion space in an axial direction to assemble the busbar to a base in which the insertion space is provided;
a second step of sliding a cover in the axial direction to assemble the cover to the base, the cover covering the insertion space from one end side in a stacking direction intersecting the axial direction; and
a third step of assembling and fixing a lock member to the base and the cover in the stacking direction, the lock member including a protrusion to be inserted into a through hole on the cover and provided to clamp the busbar between the protrusion and the base, the lock member further including a pair of locked portions, the pair of locked portions being provided at both ends in a width direction intersecting the axial direction and the stacking direction and provided to be locked to a pair of locking portions on the base in a state where the protrusion is inserted into the through hole.
